(19) United States
(12) Patent Application Publication
(10) Pub. No.: US 2023/0146931 A1
(43) Pub. Date: May 11, 2023

(54) AUTHENTICATION SURFACE FEATURE IN ADDITIVE MANUFACTURING

(71) Applicant: Hewlett-Packard Development Company, L.P., Spring, TX (US)

(72) Inventors: Wei Huang, Palo Alto, CA (US); Gary J. Dispoto, Palo Alto, CA (US)

(73) Assignee: Hewlett-Packard Development Company, L.P., Spring, TX (US)

(21) Appl. No.: 17/912,078

(22) PCT Filed: Apr. 13, 2020
(86) PCT No.: PCT/US2020/027932

§ 371 Date: Sep. 16, 2022

(51) Int. Cl. B29C 64/393; B29C 64/165

(52) U.S. Cl. CPC B29C 64/393; B29C 64/165; B33Y 10/00

(57) ABSTRACT

A device comprises a control portion to additively manufacturing a 3D object to include a first interior portion having a first thermal history different from a second thermal history of at least second interior portions surrounding the selectable first interior portion to induce an authentication surface feature at a first exterior surface portion overlying the first interior portion.

### BACKGROUND

Additive manufacturing may revolutionize design and manufacturing in producing three-dimensional (3D) objects. Some forms of additive manufacturing may sometimes be referred to as 3D printing, and may produce 3D objects with various surface characteristics.

### BRIEF DESCRIPTION OF THE DRAWINGS

FIG. 1 is a block diagram schematically representing an example device and/or example method of additively manufacturing an example 3D object to include an example first exterior surface portion including an example authentication surface feature.

FIG. 2 is a diagram including a top elevational view schematically representing an example first exterior surface portion including an example authentication surface feature.

FIG. 3 is a diagram including a side view schematically representing a portion of an example first exterior surface portion including an example authentication surface feature.

FIG. 4 is a block diagram schematically representing an example device and/or example method to additively manufacture a 3D object.

FIG. 5A is diagram including a top sectional view schematically representing an example embedded portion of a partially formed example 3D object.

FIG. 5B is diagram including a top elevational view schematically representing an example first exterior surface portion, including an example authentication surface feature, of an example 3D object.

FIG. 6 is diagram including a front elevational view schematically representing an example 3D object, which includes a first exterior surface portion comprising an authentication surface feature.

FIG. 7A is a diagram including a side sectional view schematically representing an example 3D object, including an example first interior portion including an example embedded portion.

FIG. 7B is diagram including a top elevational view schematically representing an example first exterior surface portion, including an example authentication surface feature, of an example 3D object.

FIG. 8 is a diagram including a block diagram schematically representing a device to obtain, store, and/or evaluate images of an authentication surface feature of a 3D object.

FIG. 9A is block diagram schematically representing an example object formation engine.

FIG. 9B is block diagram schematically representing an example control portion.

FIG. 9C is a block diagram schematically representing an example user interface.

FIG. 10A is flow diagram schematically representing an example method of additively manufacturing a 3D object with a surface feature variation for authentication.

FIG. 10B is a diagram schematically representing an example method of obtaining and storing images of a surface feature variation of an additively manufactured 3D object.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

At least some examples of the present disclosure provide for additively manufacturing a 3D object to include a first interior portion having a first thermal history different from a second thermal history of at least second interior portions surrounding the first interior portion to induce an authentication surface feature at a first exterior surface portion overlying the first interior portion.

In some examples, the first interior portion comprises an embedded portion which, in some examples, may comprise a first degree of fusion selectably different from a degree of fusion of the second interior portions. The first degree of fusion may be implemented by altering a volume of fusing agent and/or detailing agent applied to the build material which forms the embedded portion, such that the embedded portion may comprise unfused build material or partially fused build material. In some such examples, all of the build material forming the embedded portion may comprise the same degree of fusion, whether all the build material is unfused or all of the build material comprises the same degree of partial fusion.

However, in some examples the device can control a degree of fusion on a voxel-by-voxel basis, via controlling a volume and/or location of application of the fusing agent and/or detailing agent. Accordingly, in some examples the embedded portion may comprise a non-uniform array of voxel locations in which some voxel locations comprise unfused build material and some voxels locations comprise partially fused build material. Moreover, in some such examples, the non-uniform array of voxel locations may comprise some voxel locations with fully fused build material along with some voxel locations which are unfused and/or which are partially fused.

In some examples, a device and/or method comprises selecting a location, shape, and/or volume of the embedded portion, which also may specify a depth of the embedded portion relative to an exterior surface portion of the 3D object at which an authentication surface feature will appear.

These arrangements will produce a first thermal history for the first interior portion which is different from a second thermal history of second interior portions which surround the first interior portion, wherein the second thermal history is generally uniform and thereby results in a generally uniform exterior surface appearance at a second exterior surface portion surrounding the first exterior surface portion defined by the authentication surface feature.

In remaining unfused or becoming just partially fused, the embedded portion (at least partially defining the first interior portion) does not experience the same degree of thermal energy as the surrounding second interior portions, and subsequent additive layers (of the first interior portion) above the embedded portion will experience different thermal characteristics from subsequent additive layers of the surrounding second interior portions. Assuming that the embedded portion is formed at an appropriate depth, this altered thermal profile of the first interior portion will ultimately influence the last or top additive layer overlying the first interior portion (including embedded portion) such that the last or top layer will become overfused and thereby exhibit the random characteristics exhibited by the authentication surface feature. Such random characteristics may comprise variations in the surface appearance (as compared to a uniform appearance) regarding a color, shape, area, topography, degree of powder attachment, and the like. In some examples, the color variations may be grey-scale variations and/or different hues in a color space (e.g. CYMK). In some examples, the authentication surface feature may sometimes be referred to as an authentication surface mark, authentication surface colorization, surface feature variation, and the like.

A selectable variability in the degree of fusion of, and/or selectable variability in the location, shape, and volume of, the embedded portion facilitates randomness in the thermal history of the first interior portion, including layers overlying the embedded portion. The randomness of the thermal history may contribute to the randomness of characteristics, such as a color, shape, area, etc. of the authentication surface feature overlying the first interior portion (including the embedded portion). The randomness of these characteristics makes it much more difficult, if not impossible, for a counterfeiter to reproduce the authentication surface feature of the 3D object.

In some examples, the location, shape, and/or volume of the embedded portion as a whole (or some voxel locations therein) may be randomly selected. In some examples, the degree of fusion of the embedded portion as a whole (or some voxel locations therein) may be randomly selected, which may or may not occur in conjunction with random selection of the location, shape, and/or volume of the embedded portion. Such random selection may further contribute to the random characteristics of the surface authentication feature overlying the embedded portion of the first interior portion at least because such random selection influences the thermal history of the first interior portion in unpredictable ways.

Once a 3D object is formed according to the above-described examples, the 3D object will include a first exterior surface portion including an authentication surface feature. With this in mind, in some examples a device may be used to obtain and store images of the authentication surface feature for later use in authenticating a 3D object, and thereby preventing successful counterfeiting and/or deterring counterfeiting.

Accordingly, while the flexibility of additively manufacturing may tempt a counterfeiter to make counterfeit copies of particular 3D objects, the examples of the present disclosure provide a pathway to prevent success in such counterfeiting because of the irreproducibility of each unique authentication surface feature for any particular 3D object.

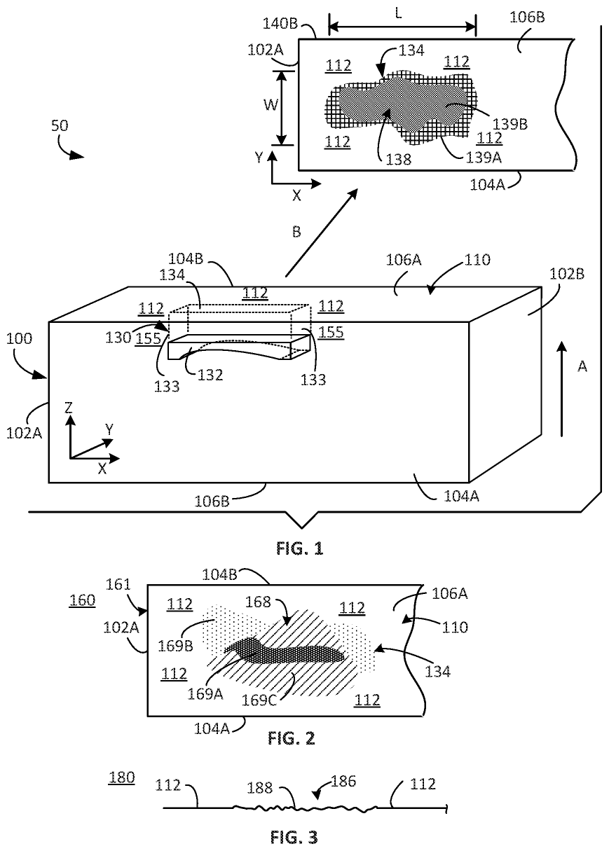

These examples, and additional examples, are further described in association with at least FIGS. 1-10B.

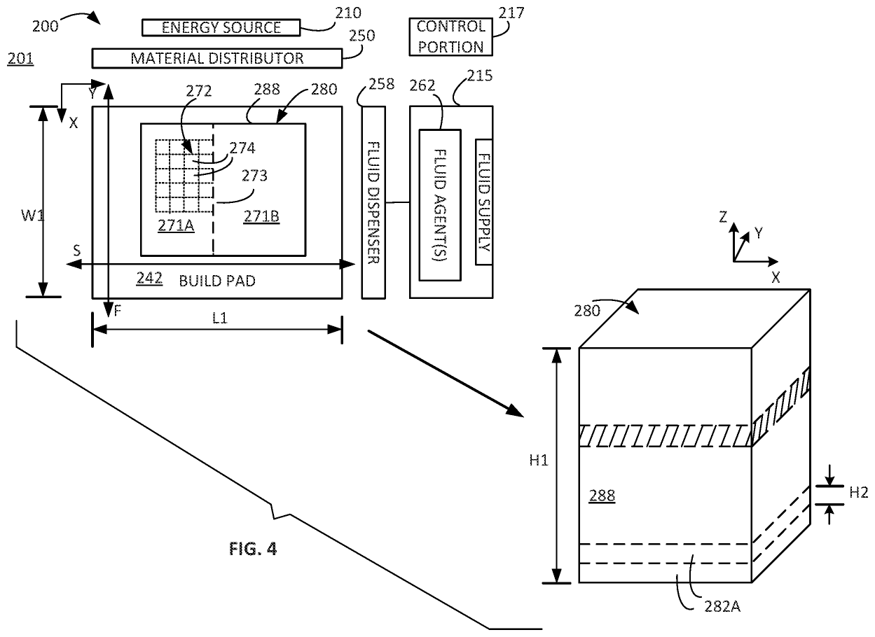

FIG. 1 is a diagram schematically representing an example device 50 (and/or method) to additively manufacture an example 3D object 100 including a first exterior surface portion 134 which includes an authentication surface feature 138. As shown in FIG. 1, example 3D object 100 comprises opposite ends 102A, 102B, top 106A, bottom 106B, and a front side 104A, opposite back side 104B. 3D object 100 is additively formed beginning at the bottom (e.g. 106B) and upward toward the top 106A, as represented by directional arrow A. In some examples, the 3D object 100 in FIG. 1 may be additively manufactured via at least some of the features and attributes of the device 200 described and illustrated later in association with at least FIG. 4.

In some examples, in order to facilitate future authentication of the 3D object 100, during the layer-by-layer additive manufacturing of the 3D object 100, a first interior portion 130 is caused to have a first thermal history which is different from a second thermal history of second interior portions 155 surrounding the first interior portion 130. By doing so, a first exterior surface portion 134 overlying the first interior portion 130 will have an appearance different from a second exterior surface portion 112 overlying the second interior portions 155, which surround the sides 133 of the first interior portion 130.

In some examples, causing the first thermal history of the first interior portion 130 comprises modifying, in comparison to the surrounding second interior portions 155, some characteristic of the additive manufacturing process in the first interior portion 130 underlying the expected first exterior surface portion 134. In some examples, a modification may comprise an alteration in a volume of fusing agent and/or a detailing agent applied to the build material in forming the 3D object in the location of the first interior portion 130.

For instance, as shown in FIG. 1, in some examples one modification may comprise forming an embedded portion 132 (shown in solid lines) at a bottom portion 135 of the first interior portion 130, wherein the embedded portion 132 corresponds to a volume of build material which is unfused or partially fused. As a result, a degree of fusion of the embedded portion 132 is selectably different from a degree of fusion (e.g. fully fused) of the second interior portions 155 surrounding the embedded portion 132 (of the first interior portion 130). In some examples, the embedded portion 132 is formed by omitting application of a fusing agent and/or detailing agent, such that embedded portion 132 comprises free build material, such as free powder build material. In some examples, the embedded portion 132 may be formed by applying a reduced volume of fusing agent and/or detailing agent, such the build material of embedded portion 132 is just partially fused instead of being fully fused.

Once the embedded portion 132 is formed as part of one or several layers in additively manufacturing 3D object 100, then subsequent layers of the 3D object (represented by portion 137 within dashed lines) will form the remainder of the interior portion 130, which underlies the first exterior surface portion 134. However, the subsequent layers forming the remaining portion (137) of the first interior portion 130 will experience a thermal history which no longer corresponds to a thermal history of the same subsequent layers in the surrounding second interior portions 155 surrounding the first interior portion 130. Consequently, upon application of the last layer to additively form the exterior surface portion 110 of the top 106A of the 3D object, the first exterior surface portion 134 overlying the first interior portion 130 will exhibit surface characteristics which are different from the surface characteristics of the second exterior surface portion 112 surrounding the first exterior surface portion 134. The primary surface characteristics of the first exterior surface portion 134 include a change in color, which may be a change in grey-scale values or a change in hue (e.g. for a CYMK color space), as compared to a substantially uniform color of the surrounding second exterior surface portion 112.

This surface feature variation apparent in the first surface exterior portion 134 will enable later authentication of the 3D object because of its uniqueness and irreproducibility. In particular, it would be difficult, if not impossible, for a counterfeiter to reproduce the exact same surface feature as first exterior portion 134 at least because the surface feature exhibits at least some random characteristics in view of how and why the first surface feature is generated.

As indicated by directional arrow B, the first exterior surface portion 134 is further illustrated schematically in FIG. 1 and is further defined as authentication surface feature 138, i.e. an authentication surface mark. It will be understood that an actual surface feature may not exhibit any particular pattern, and may exhibit a range of colors (e.g. grey scale values, hues, etc.), may have irregular borders, etc. Accordingly, it will be understood that the appearance of the authentication surface feature 138 in FIG. 1 is merely for illustrative purposes and is not limiting regarding the shapes, sizes, colors, etc. of an actual surface feature for first exterior surface portion 134 because of its altered thermal history (as compared to the surrounding second interior portions 155).

In some examples, the authentication surface feature 138 may be characterized by its location, such as via x, y coordinates on the top portion 106A of 3D object 100, and/or characterized according to its size (e.g. area) which may include measurements of length (L) and/or width (W). The authentication surface feature 138 also may be characterized by greyscale levels, hues, patterns (or lack thereof), border shapes, etc. For example, one non-limiting example schematically representing an authentication surface feature 138 comprises portion 139B juxtaposed with portion 139A. As previously noted, this appearance comprises random characteristics not specifically selected upon initiating additive formation of the 3D object 100, and not reproducible because of the random nature in the way such surface features are generated by causing an alteration in the thermal history of a first interior portion 130 of the 3D object 100. As later described in association with at least FIG. 8, a device 681 including an imager 672 may be used to objectively identify the unique characteristics (e.g. location, size, area, colors, etc.) of the authentication surface feature 138 of the first exterior surface portion 134, and/or of second exterior surface portions 112.

It will be understood, from the foregoing examples and at least some following examples, that introducing an embedded portion 132 below the general exterior surface portion 110 of the 3D object 100 (as shown in FIG. 1) is a modification made within the interior of the 3D object 100 to cause a change in the thermal history of portions (e.g. 137 in FIG. 1) above the embedded portion 132, which extend up to, and include an altered thermal history and behavior at the first exterior surface portion 134 at which the authentication surface feature 138 exhibits random surface characteristics.

However, in some examples, a modification also may include intentionally modifying the exterior surface portion 110 directly at the first exterior surface portion 134 (to cause some random surface feature characteristics) in addition to the previously described intentional modification of introducing the embedded portion 132 at some depth below the general exterior surface portion 110 (which includes the first exterior surface portion 134) in order to cause random surface characteristics. In some such examples, intentionally modifying both interior portions and exterior surface portions of the 3D object to cause an authentication surface feature (e.g. 138) may enhance the effectiveness of the authentication surface feature in becoming uniquely distinctive (by exhibiting random surface characteristics) and difficult to reproduce, thereby further hampering successful attempts at counterfeiting the 3D object (including its authentication surface feature). At least some of the uniqueness of the authentication surface feature arises from the random characteristics in thermal behavior caused by the intentional internal modification and the intentional external modification of thermal behavior and history associated with the first surface exterior portion 134. It will be further understood that the example of intentionally modifying the exterior surface portion (e.g. 110) at a first exterior surface portion 134 (which overlies the embedded portion 132), in combination with the intentional internal modification implemented via the interiorly-located embedded portion 132, may be applied to at least some of the later described examples of the present disclosure.

FIG. 2 is diagram 160 including a top plan view of an example authentication surface feature of a 3D object 161. In some examples, the 3D object 161 may comprise a first interior portion like first interior portion 130 of 3D object 100 in FIG. 1, and yet result in an authentication surface feature 168 (at first exterior surface portion 134) which is different from the authentication surface feature 138 shown in FIG. 1. In one aspect, this situation arises from the development of random characteristics as subsequent layers forming first interior portion 130 are added above the embedded portion 132.

However, in some examples, the first interior portion 130 may comprise a differently shaped and/or sized embedded portion 132, or may comprise a different degree of fusion, etc. All of these variations would contribute to the development of random characteristics in the thermal history of a first interior portion, further ensuring that the resulting authentication surface feature will have a unique appearance.

As further shown in FIG. 2, the second exterior surface portion(s) 112, which surround the authentication surface feature 168 at first surface exterior portion 134, exhibit a substantially uniform appearance.

As shown in FIG. 2, in some examples the authentication surface feature 168 comprises portions 169A, 169B, 169C which are juxtaposed with each other. As previously noted, this example surface feature is merely a simplistic schematic representation, wherein an actual surface feature may exhibit more complexity (or less complexity) in its shape, size, colors (e.g. gray-scale variations, hues), patterns, lack of pattern, randomness, etc.

As schematically represented in the side view of diagram 180, in some examples, a first exterior surface portion 186 (including an authentication surface feature) may exhibit changes in a texture, porosity, etc., as represented by the irregular topography at surface portion 188 (of the first exterior surface portion 186) as compared to the relatively smooth surface portions 190 of the surrounding second exterior surface portion 112. Accordingly, in some examples, such topographic variations may be present along with changes in color, shape, size, etc. associated with an authentication surface feature (e.g. 168 in FIG. 2).

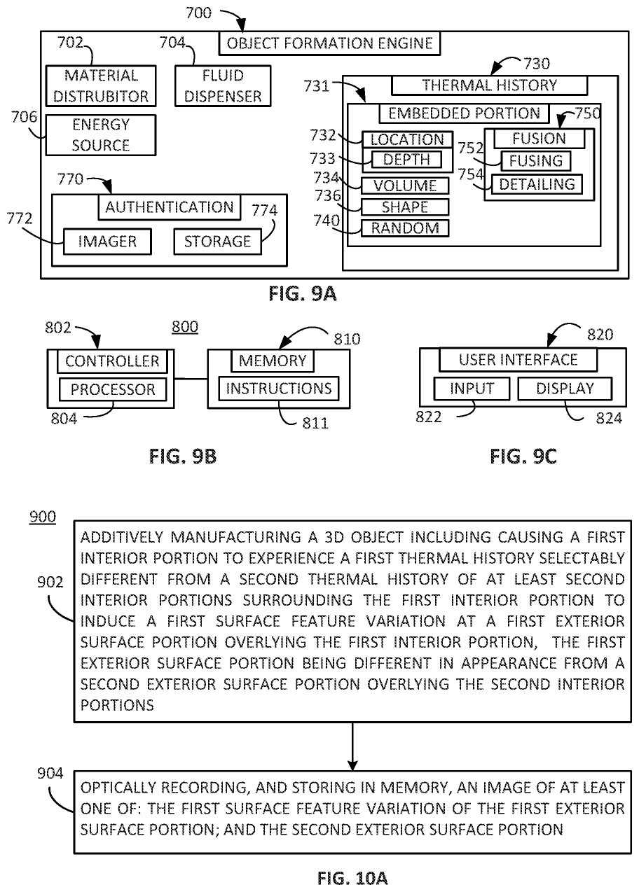

As further described later in association with at least FIGS. 9A-10B, in some examples, the operation of device 50 in FIG. 1 may be embodied in the form of instructions stored in non-transitory machine-readable medium (and executable via a processor), while in some examples, a printer control portion may be programmed to cause such operation of device 50.

It will be understood that an authentication surface feature 138, 168 may be implemented without changing the type or volume of build material for that first interior portion 130 (for which a modified thermal history will be produced) and/or without changing a boundary geometry of the 3D object in the region at which the first thermal history of the first interior portion (e.g. 130 in FIG. 1) is being generated.

FIG. 4 is a diagram schematically representing an example device 200 to additively manufacture an example 3D object 280 including an authentication surface feature, such as provided via the examples previously described in association with at least FIGS. 1-3. Accordingly, the device 200 in FIG. 4 may comprise one example implementation of the arrangement 50 in FIG. 1 and/or comprise at least some of substantially the same features and attributes for additively manufacturing a 3D object as previously described in association with FIGS. 1-3.

As shown in FIG. 4, in some examples, the device 200 comprises a material distributor 250 and a fluid dispenser 258. The material distributor 250 is arranged to dispense a build material layer-by-layer onto a build pad 242 to additively form the 3D object 280. Once formed, the 3D object 280 may be separated from the build pad 242. It will be understood that a 3D object of any shape and any size can be manufactured, and the object 280 depicted in FIG. 4 provides just one example shape and size of a 3D object. In some instances device 200 may sometimes be referred to as a 3D printer. Accordingly, the build pad 242 may sometimes be referred to as a print bed or a receiving surface.

It will be understood that the material distributor 250 may be implemented via a variety of electromechanical or mechanical mechanisms, such as doctor blades, slot dies, extruders, and/or other structures suitable to spread, deposit, and/or otherwise form a coating of the build material in a generally uniform layer relative to the build pad 242 or relative to a previously deposited layer of build material.

In some examples, the material distributor 250 has a length (L1) at least generally matching an entire length (L1) of the build pad 242, such that the material distributor 250 is capable of coating the entire build pad 242 with a layer 282A of build material in a single pass as the material distributor 250 travels the width (W1) of the build pad 242. In some examples, the material distributor 250 can selectively deposit layers of material in lengths and patterns less than a full length of the material distributor 250. In some examples, the material distributor 250 may coat the build pad 242 with a layer 282A of build material(s) using multiple passes instead of a single pass.

It will be further understood that a 3D object additively formed via device 200 may have a width and/or a length less than a width (W1) and/or length (L1) of the build pad 242.

In some examples, the material distributor 250 moves in a first orientation (represented by directional arrow F) while the fluid dispenser 258 moves in a second orientation (represented by directional arrow S) generally perpendicular to the first orientation. In some examples, the material distributor 250 can deposit material in each pass of a back-and-forth travel path along the first orientation while the fluid dispenser 258 can deposit fluid agents in each pass of a back-and-forth travel path along the second orientation. In at least some examples, one pass is completed by the material distributor 250, followed by a pass of the fluid dispenser 258 before a second pass of the material distributor 250 is initiated, and so on.

In some examples, the material distributor 250 and the fluid dispenser 258 can be arranged to move in the same orientation, either the first orientation (F) or the second orientation (S). In some such examples, the material distributor 250 and the fluid dispenser 258 may be supported and moved via a single carriage while in some such examples, the material distributor 250 and dispenser 258 may be supported and moved via separate, independent carriages.

In some examples, the build material used to generally form the 3D object comprises a polymer material. In some examples, the polymer material comprises a polyamide material. However, a broad range of polymer materials (or their combinations) may be employed as the build material. In some examples, the build material may comprise a ceramic material. In some examples, the build material may take the form of a powder while in some examples, the build material may take a non-powder form, such as liquid or filament. Regardless of the particular form, at least some examples of the build material is suitable for spreading, depositing, extruding, flowing, etc. in a form to produce layers (via material distributor 250) additively relative to build pad 242 and/or relative to previously formed first layers of the build material.

In some examples, the fluid dispenser 258 shown in FIG. 4 comprises a printing mechanism, such as an array of printheads, each including a plurality of individually addressable nozzles for selectively ejecting fluid agents onto a layer of build material. Accordingly, in some examples, the fluid dispenser 258 may sometimes be referred to as an addressable fluid ejection array. In some examples, the fluid dispenser 258 may eject individual droplets having a volume on the order of ones of picoliters or on the order of ones of nanoliters.

In some examples, fluid dispenser 258 comprises a thermal inkjet (TIJ) array. In some examples, fluid dispenser 258 may comprise a piezoelectric inkjet (PIJ) array or other technologies such as aerosol jetting, anyone of which can precisely, selectively deposit a small volume of fluid. In some examples, fluid dispenser 258 may comprise continuous inkjet technology.

In some examples, the fluid dispenser 258 selective dispenses droplets on a voxel-by-voxel basis. In one sense a voxel may be understood as a unit of volume in a three-dimensional space. In some examples, a resolution of 1200 voxels per inch in the x-y plane is implemented via fluid dispenser 258. In some examples, a voxel may have a height H2 (or thickness) of about 100 microns, although a height of the voxel may fall between about 80 microns and about 100 microns. However, in some examples, a height of a voxel may fall outside the range of about 80 to about 100 microns. FIG. 4 also illustrates the fully formed 3D object 280 having a height H1.

In some examples, the height (H2) of the voxel may correspond to a thickness of one layer (e.g. 282A) of the build material.

In some examples, the fluid dispenser 258 has a width (W1) at least generally matching an entire width (W1) of the build pad 242, and therefore may sometimes be referred to as providing page-wide manufacturing (e.g. page wide printing). In such examples, via this arrangement the fluid dispenser 258 can deposit fluid agents onto the entire receiving surface in a single pass as the fluid dispenser 258 travels the length (L1) of the build pad 242. In some examples, the fluid dispenser 258 may deposit fluid agents onto a given layer of material using multiple passes instead of a single pass.

In some examples, fluid dispenser 258 may comprise, or be in fluid communication with, an array of reservoirs to contain various fluid agents 262. In some examples, the array of reservoirs may comprise a fluid supply 215. In some examples, the fluid supply 215 comprises reservoirs to hold various fluids, such as a carrier (e.g. ink flux) by which various agents may be applied in a fluidic form.

In some examples, at least some of the fluid agents 262 may comprise a fusing agent, a color agent, detailing agent, etc. to enhance formation of each layer 282A of build material. In particular, upon application onto the build material at selectable positions via the fluid dispenser 258, the respective fusing agent and/or detailing agent may diffuse, saturate, and/or blend into the respective layer of the build material at the selectable positions. As noted elsewhere, a volume and/or location of application of the fusing agent and/or detailing agent on particular portions of the build material may be used to selectively control a degree of fusion (e.g. solidification), porosity, and/or density of the build material and therefore modify or control at least one thermal parameter (e.g. conductivity, heat capacity, specific heat capacity) of the particular portions of the build material. Moreover, by controlling these characteristics of the particular portions, one may control at least one thermal parameter of the entire 3D object or portions thereof.

As further shown in FIG. 4, in some examples, the at least partially formed 3D object 280 comprises a first portion 271A and a second portion 271B with dashed line 273 representing a boundary between the first portion 271A and the second portion 271B. The 3D object 280 may comprise an exterior side surface 288.

During formation of a desired number of layers 282A of the build material, in some examples the fluid dispenser 258 may selectively dispense droplets of fluid agent(s) 262 at some first selectable voxel locations 274 of at least some respective layers 282A to at least partially define the first portion 271A of the 3D object. It will be understood that a group 272 of first selectable voxel locations 274, or multiple different groups 272 of first selectable voxel locations 274 may be selected in any position, any size, any shape, and/or combination of shapes.

In some examples, the at least some first selectable voxel locations 274 may correspond to an entire layer 282A of a 3D object or just a portion of a layer 282A. Meanwhile, in some examples, the 3D object may comprise a part of a larger object. In some examples, each first selectable voxel location 274 corresponds to a single voxel.

As further shown in FIG. 4, in some examples device 200 comprises an energy source 210 for applying energy (e.g. irradiating) to the deposited build materials, fluid agents (e.g. fusing agent, detailing agent, etc.) to cause heating of the material, which in turn results in the fusing of particles of the material relative to each other, with such fusing occurring via melting, sintering, etc. In portions of the 3D object in which full solidification is desired, such as for structural purposes, then a full volume of the respective fusing agents and/or detailing agents are applied to those portions of the 3D object. However, as noted elsewhere previously, in portions of the 3D object for which a modification at least one thermal parameter (e.g. conductivity, heat capacity, specific heat capacity) is to be implemented, then a lower volume of the respective fusing agent(s) and/or detailing agent(s) are to be applied.

After application of the radiation from energy source 210, a layer 282A of build material is formed and additional layers 282A of build material may be formed in a similar manner as represented in FIG. 4. In view of the foregoing examples, it will be understood that any given formed layer 282A of build material may include at least some portions which are unfused or partially fused in order to achieve the target thermal parameter objectives.

In some examples, the energy source 210 may comprise a gas discharge illuminant, such as but not limited to a Halogen lamp. In some examples, the energy source 210 may comprise multiple energy sources. As previously noted, energy source 210 may be stationary or mobile and may operate in a single flash or multiple flash mode.

As shown in FIG. 4, in some examples device 200 may comprise a control portion 217 to direct operations of device 200. In some examples, control portion 217 may be implemented via at least some of substantially the same features and attributes as control portion 800, as later described in association with at least FIG. 9B.

In some examples the device 200 in FIG. 4 can be used to additively form a 3D object via a powder bed-based process, such as MultiJet Fusion (MJF) process (available from HP, Inc.). It will be understood that in some examples other additive manufacturing techniques (e.g. Fused Deposition Modeling (FDM), Selective Laser Sintering (SLS), Selective Laser Melting (SLM), 3D binder jetting, Electron Beam Melting (EBM), ProJet Fusion, etc.) may be used for form a 3D object. In such arrangements, the selectable parameter (e.g. porosity, density, fusion) and resulting thermal parameter in the portion 90 (according to examples of the present disclosure) may be implemented according to the particular build materials, application techniques, curing techniques, etc. associated with each particular modality of manufacturing.

With further reference to at least FIGS. 1 and 4, in some examples, an authentication surface feature (e.g. 138 in FIG. 1) may be created with a first interior portion (e.g. 130 in FIG. 1)) which is not entirely surrounded by second interior portions (e.g. 155 in FIG. 1), such as if one side of the first interior portion 130 were exposed on a portion (e.g. side 104A) of the 3D object other than the side 106A at which first exterior portion 134 (including authentication surface feature 138) is located. In such an arrangement, the second interior portions 155 partially surround the first interior portion 130 (and embedded portion 132) but do not completely surround the first interior portion 130. In such arrangement, the embedded portion (e.g. 132) still influences the thermal history of the first interior portion 134 overlying the embedded portion 132. In such arrangements, it will be further understood that the side (e.g. 104A in FIG. 1) of the interior portion 130 (including embedded portion 132) which is exposed on a surface of the 3D object may be fully fused to ensure structural integrity of the 3D object and to leave the surface appearance of the side (e.g. 104A) of the 3D object unaltered. Meanwhile, other regions (e.g. a majority or super majority) of the first interior portion 130 (including the embedded portion 132) may be unfused or just partially fused to cause the alteration in the thermal history as compared to the second interior portions which to partially surround the first interior portion 130 (including the embedded portion 132).

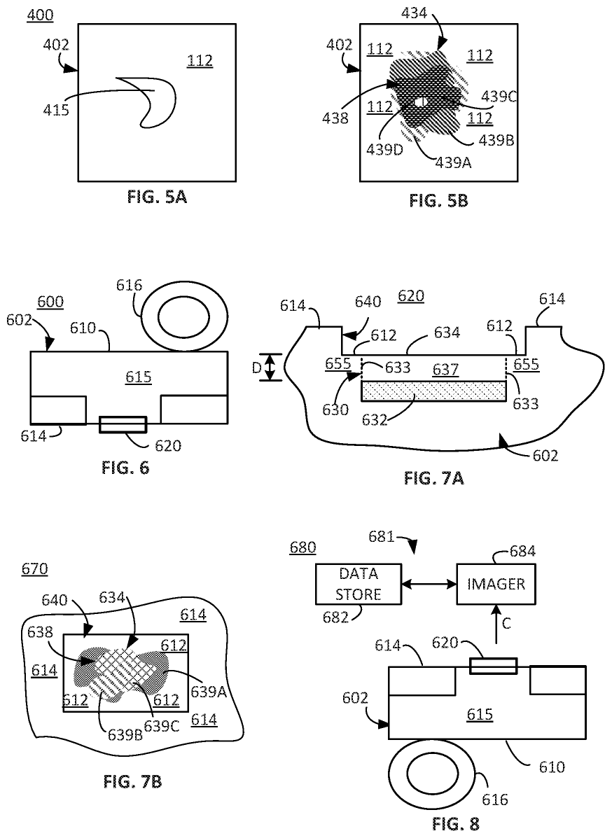

FIG. 5A is a diagram 400 including a sectional view schematically representing an example partially formed 3D object 402. In some examples, the partially formed 3D object 402 may be additively manufactured according to at least some of the same features and attributes as previously described in association with at least FIGS. 1-4. As shown in FIG. 5A, in some examples an embedded portion 415 of a first interior portion 430 has been additively formed to function in substantially the same manner as embedded portion 132 of first interior portion 130 in FIG. 1, except that in the example of FIG. 5A the embedded portion 415 has a randomly generated volume and/or shape, which may further enhance the random characteristics exhibited by the authentication surface feature 438 of the first exterior surface portion 434 shown in FIG. 5B. This arrangement, in turn, may further prevent counterfeiting by making it even more difficult for a counterfeiter to reproduce the authentication surface feature 438 of the first exterior portion 434 of the 3D object 402.

In some examples, the authentication surface feature 438 at the first exterior surface portion 434 comprises portions 439A, 439B, 439C, 439D, which are juxtaposed with each other to schematically represent random characteristics in a size, shape, location, grey-scale colorization of the random characteristics of the randomly-generated authentication surface feature 438 at the first exterior surface portion 434 of the 3D object 402.

It will be understood that in some examples, the randomly-generated volume and/or shape of the embedded portion 415 in FIG. 5A is bounded by a selectable maximum volume. In some examples, the selectable maximum volume may be implemented according to an array of three-dimensional coordinates (x, y, z). Within the three-dimensional coordinate array setting the maximum volume, the embedded portion (e.g. 132 in FIG. 1, 632 in FIG. 7A) may have any randomly-generated volume, shape, and/or location. Moreover, in some examples, the embedded portion 415 may be formed via randomly-varying amounts of the applied respective fusing agent and detailing agent at voxel locations (274) to cause a randomly-generated degree of fusion, which may enhance the generation of random characteristics of the authentication surface feature 438 at a first exterior surface portion 434 of the 3D object 402.

FIG. 6 is diagram 600 including a front view of an example 3D object 602. In some examples, the 3D object 602 is additively manufactured according to at least some of the same features and attributes as previously described in association with at least FIGS. 1-5B. In some examples, 3D object 602 may comprise a body portion 615, head portion 616, top exterior surface portion 610, and opposite bottom exterior surface portion 614. It will be understood that the particular configuration shown in FIG. 6 is not limiting in that the sense that a 3D object associated with the examples relating to FIGS. 6-8 may comprise a wide variety of shapes, sizes, configurations, purposes, etc.

While not visible in FIG. 6, in some examples the 3D object 602 includes an authentication surface feature of a first exterior surface portion (as in the previously described examples) at a region denoted by the box 620. In one aspect, this region 620 is selected for the location of the authentication surface feature because it is relatively inconspicuous and will not generally affect the overall aesthetics of the 3D object. However, other more conspicuous locations on an exterior surface portion of the 3D object may be selected to bear an authentication surface feature as desired.

FIG. 7A is diagram including a side sectional view schematically representing the region represented by box 620 in FIG. 6, and which includes of a first exterior surface portion 634 including an authentication surface feature 638 (FIG. 7B) for the 3D object 602. In some examples, the region represented via box 620 may comprise a recess 640 formed in the bottom exterior surface portion 614 of 3D object 602.

As shown in FIG. 7A, at region 620 the 3D object 602 comprises a first interior portion 630 including an embedded portion 632, which function substantially the same as the first interior portion 130 and embedded portion 132, respectively, in the example of FIG. 1. In some examples, the embedded portion 632 may comprise a selectable shape and/or volume (at the selected region 620), or may comprise a randomly-generated shape and/or volume at the selected location. In addition, the depth D may be selected or randomly-generated (within a selectable limit).

As further shown in FIG. 7A, the first interior portion 630 (represented via dashed lines) is surrounded by second interior portions 655 above which is an overlying second exterior surface portion 612. The first interior portion 630 includes sides 633 (like sides 133 in FIG. 1), and includes portion 637 (like portion 137 in FIG. 1). The second exterior surface portion 612 forms part of a bottom exterior surface portion 614, which is generally opposite a top exterior surface portion 610 of the 3D object 602.

FIG. 7B is diagram 670 including a top view schematically representing one example implementation of a first exterior surface portion 634 of 3D object 602 (FIG. 6), including an authentication surface feature 638. As shown in FIG. 7B, the authentication surface feature 638 comprises portions 639A, 639B, 639C, which schematically represent random characteristics of the authentication surface feature generated from the thermal history of first interior portion 630, including embedded portion 632 shown in FIG. 7A. It will be understood that when a second identical 3D object (like 602 in FIG. 6) is be additively manufactured including an embedded portion (e.g. 632 in FIG. 7A) identical to the one which produced the first exterior surface portion 634 shown in FIG. 7B, the second 3D object will exhibit a first exterior surface portion 634 exhibiting an authentication surface feature different from the authentication surface feature schematically represented in FIG. 7B. Like the first exterior surface portion 634 in FIG. 7B, the first exterior surface portion 634 of the second identical 3D object will exhibit random characteristics in its shape, size (e.g. area), colorization, etc. but which are different from the random characteristics (in shape, size, colorization, etc.) for the first 3D object 602.

FIG. 8 is a diagram 680 schematically representing an example device 681 to at least obtain and store images of an authentication surface feature from an authentic 3D object 602. In some examples, the 3D object 602 may be additively manufactured according to a device and/or method comprising at least some of substantially the same features and attributes as the examples previously described in association with at least FIGS. 1-7B so that the 3D object 602 will comprise a first surface exterior portion (e.g. 634 in FIGS. 7A-7B) including an authentication surface feature (e.g. 638 in FIG. 7B)

As shown in FIG. 8, in some examples, device 681 comprises an imager 684 and a data store 682. After complete formation of an authentic 3D object 602, the imager 684 is to obtain images of the first exterior surface portion (e.g. 634 in FIG. 7B), including authentication surface feature (e.g. 638 in FIG. 7B), and of at least some portion of the surrounding second surface exterior portions (e.g. 112 in FIG. 1; 612 in FIGS. 7A-7B). The obtained images of the respective first and second exterior portions 134, 112 of the authentic 3D object are stored in data store 682 for later use in authenticating, e.g. determining whether a particular 3D object is authentic. In such an arrangement, at a later time when it is desired to determine the authenticity of a candidate 3D object, the imager 684 is operated to obtain an image of an exterior surface portion of the candidate 3D object (e.g. 602) such as at a region denoted by box 620. The obtained image 685 is compared to stored images in data store 682 to determine whether the exterior surface portion (e.g. like 634, 612) of the candidate 3D object captured in the obtained image includes a first exterior surface portion 634 (including an authentication surface feature 638 in FIG. 7B) which matches a stored image, for an authentic 3D object, of a first exterior surface portion 634 (including an authentication surface feature 638 in FIG. 7B). If there is a match, then the candidate 3D object may be deemed authentic, i.e. the same as the original authentic 3D object. If there is no match, then the candidate 3D object may be deemed inauthentic or a counterfeit, i.e. is not the same as the original, authentic object.

Similarly, as previously noted, one can obtain and store images of the second exterior surface portions 612 of a known authentic 3D object, which can later be compared with corresponding second exterior surface portions 612 of a candidate 3D object to determine whether the candidate 3D object is authentic or not. This comparison may be performed in conjunction with, or separate from, the comparison of the first exterior surface portions noted above.

It will be understood that in some examples, operation of the imager 684 and/or data store 682 may be implemented in association with a control portion, such as control portion 800 later described in association with FIG. 9B. In some such examples, at least a portion of control portion 800 may be incorporated into device 681. In some examples, the data store 682 may comprise at least some of substantially the same features and attributes as memory 810 in FIG. 9B.

FIG. 9A is a block diagram schematically representing an example object formation engine 700. In some examples, the object formation engine 700 may form part of a control portion 800, as later described in association with at least FIG. 9B, such as but not limited to comprising at least part of the instructions 811. In some examples, the object formation engine 700 may be used to implement at least some of the various example devices and/or example methods of the present disclosure as previously described in association with FIGS. 1-8 and/or as later described in association with FIGS. 9B-10B. In some examples, the object formation engine 700 (FIG. 9A) and/or control portion 800 (FIG. 9B) may form part of, and/or be in communication with, an object formation device. Accordingly, in some examples, at least some aspects of control portion 800 may comprise one example implementation of the control portion 217 of device 200 in FIG. 4.

As shown in FIG. 9A, in some examples the object formation engine 700 may comprise a material distributor engine 702, fluid dispenser engine 704, energy source engine 706.

As shown in FIG. 9A, in some examples the material distributor engine 702 controls distribution of layers of build material relative to build pad (e.g. 242 in FIG. 4) and/or relative to previously deposited layers of build material. In some examples, the material distributor engine 702 comprises a material parameter to specify which material(s) and the quantity of such material which can be used to additively form a body of the 3D object. In some examples, these materials are deposited via build material distributor 250 of device 200 (FIG. 4).

In some examples, the material controlled material distributor engine 702 may comprise polymers, ceramics, etc. having sufficient strength, formability, toughness, etc. for the intended use of the 3D object with at least some example materials being previously described in association with at least FIG. 4.

As shown in FIG. 9A, in some examples the fluid dispenser engine 704 may specify which fluid agents are to be selectively deposited onto a layer (or portions of a layer) of build material on a voxel-by-voxel basis, as previously described in association with at least FIG. 4. In some examples, such agents are deposited via fluid dispenser 258 (FIG. 4). In some examples, the fluid dispenser engine 704 may comprise a carrier function and an agent function to apply fluid agents, such as the carrier, fusing, detailing, etc. as previously described in association with at least FIG. 4.

In particular, via the fluid dispenser engine 704, application of a selectable volume (and location) of a fusing agent and/or detailing agent may be used to selectably control a degree of fusion at selectable voxel locations (274 in FIG. 4). In some such examples, such control may be used to influence a thermal history of a portion of a 3D object to cause an authentication surface feature, as described in previous examples and as later further described in association with fusion parameter 750 of thermal history engine 730. In some examples, fluid dispenser engine 704 may specify a number of fluid application channels, volume of fluid to be applied, during which pass the particular fluid channel is active, etc.

In some examples, the energy source engine 706 of object formation engine 700 is to control operations of at least one energy source (e.g. 210 in FIG. 4). In some examples, the energy source engine 706 may control an amount of time that energy (e.g. radiation) from the energy source 210 (FIG. 4) is emitted toward the material, agents, etc. on a layer of build material, with a resulting degree of fusion depending on a volume (and location) of fusing agent(s) and/or detailing agent(s) applied at particular voxel locations (274 in FIG. 4). As further described later in association with fusion parameter 750 of the thermal history engine 730, such control over a degree of fusion may be applied to an embedded portion (e.g. 132 in FIG. 1; 632 in FIG. 7A) to intentionally influence a thermal history of a first interior portion (e.g. 130 in FIG. 1; 630 in FIG. 7A) to produce an authentication surface feature (e.g. 138 in FIG. 1; 638 in FIG. 7B). In some examples, the energy source 706 may irradiate the targeted layer (of the 3D object under formation) in a single flash or in multiple flashes. In some examples, the energy source may remain stationary (i.e. static) or may be mobile. In either case, during such irradiation, the energy source engine 706 controls the intensity, volume, and/or rate of irradiation.

As further shown in FIG. 9A, in some examples, the object formation engine 700 comprise a thermal history engine 730, which is to control formation of at least an embedded portion (e.g. 132 in FIG. 1, 632 in FIG. 7A) to cause a resulting thermal history suited to produce a first exterior surface portion, including an authentication surface feature, as previously described in various examples throughout the present disclosure. Accordingly, in some examples, the thermal history engine 730 comprises an embedded portion engine 731 which is to control various aspects of forming an embedded portion.

In some examples, the embedded portion engine 731 comprises a location parameter 732, a volume parameter 734, a shape parameter 736, a random parameter 740 and/or a fusion parameter 750.

In some examples, in order to produce a first exterior surface portion (e.g. 134 in FIG. 1; 634 in FIG. 7B) including an authentication surface feature (e.g. 138 in FIG. 1; 638 in FIG. 7B), an embedded portion (e.g. 132 in FIG. 1; 632 in FIG. 7A) may be implemented to have a selectable location (parameter 732), volume (parameter 734), and/or shape (parameter 736) within a 3D object (e.g. 602). In some such examples, the volume can be specified as an absolute volume or as a relative volume of the 3D object 602.

In some examples, the selectable location (732) may comprise specifying a location within the 3D object at which the embedded portion will be formed, and may be expressed via three-dimensional (x, y, z) coordinates of the boundaries of the embedded portion. In some such examples, the location of the embedded portion may be specified according to a selectable depth (parameter 733) below an exterior surface portion of the 3D object at which the first exterior surface portion (including an authentication surface feature) is targeted for appearance. One example illustrating such depth is shown in FIG. 7A in which embedded portion 632 is shown being located at a depth D underlying first exterior surface portion 634. It will be understood that the selected depth of the embedded portion (e.g. 632 in FIG. 7A) will have an influence on type, size, intensity, etc. of the random characteristics of the first exterior surface portion (e.g. 634 in FIG. 7B) including the authentication surface feature (e.g. 638 in FIG. 7B) because of the random aspects of the thermal history of the first interior portion 630 ensuing after formation the embedded portion (e.g. 632).

In some examples, the random parameter 740 of the embedded portion engine 731 may be employed to introduce randomness into at least one of the location (732), volume (734), and/or shape (736) of the embedded portion (e.g. 632 in FIG. 7A). In one aspect, employing such randomness in formation of the embedded portion (e.g. 632 in FIG. 7A) may contribute to number, type, quality, etc. of random characteristics exhibited in a first exterior surface portion (e.g. 634 in FIG. 7B) including an authentication surface feature (e.g. 638 in FIG. 7B). In some examples, the random parameter 740 also may be employed to introduce randomness regarding a degree of fusion in association with fusion engine 750, as further described below.

In some examples, in cooperation with the fluid dispenser engine 704, the degree of fusion engine 750 (of thermal history engine 730) may be employed to control a degree of fusion for all of, or portions of, an embedded portion (e.g. 632 in FIG. 7A) in order to influence a thermal history of a first interior portion (including embedded portion) underlying a first exterior surface portion (e.g. 634 in FIG. 7A, 7B) in order to influence appearance of the authentication surface feature (e.g. 638 in FIG. 7B), such as its random characteristics.

In some examples, the degree of fusion engine 750 (of the thermal history engine 730) may provide control over a fusing agent parameter 752 and/or a detailing agent parameter 754, which in turn control a volume and location at which a fusing agent and/or a detailing agent, respectively, are deposited onto a layer of build material. The relative volume of the fusing agent and/or detailing agent deposited to a particular voxel location (e.g. 274) determines a degree of fusion of the particular voxel location, as previously described in association with at least FIG. 4. In particular, in the absence of a fusing agent and/or detailing agent applied to a particular voxel location and upon application of radiation per energy source (e.g. 210 in FIG. 4), no fusion will take place for the particular voxel location(s) 274 (FIG. 4). This will result in unfused build material (i.e. free powder build material) at the particular voxel location(s) 274. In some examples, the entire embedded portion (e.g. 632 in FIG. 7A) may comprise unfused build material, which will affect the thermal history of additively formed layers overlying the embedded portion. On the other hand, upon depositing a selectable volume of fusing agent and/or detailing agent to a particular voxel location(s) 274, one can control a degree of fusion of the build material at the particular voxel location(s) 274. Via this arrangement, the particular voxel location(s) 274 may become at least partially fused and in some instances, fully fused. This arrangement also will affect the thermal history of additively formed layers overlying the embedded portion in a manner to produce different random characteristics of the overlying first surface exterior portion (e.g. 634 in FIGS. 7A, 7B) including an authentication surface feature (e.g. 638 in FIG. 7B).

As further shown in FIG. 9A, in some examples, the degree of fusion engine 750 may be employed in association with the random parameter 740 of embedded portion engine 731 to introduce randomness into the volume, location, etc. of application of the fusing agent and/or detailing agent to thereby introduce randomness into the degree of fusion, in order to influence the thermal history of the first interior portion (e.g. 630), thereby contributing to the randomness of characteristics of the authentication surface feature (e.g. 638 in FIG. 7B).

It will be understood that various functions and parameters of object formation engine 700 may be operated interdependently and/or in coordination with each other, in at least some examples.

In some examples, the object formation engine 700 comprises an authentication engine 770 to track and/or control at least an imager parameter 772 and a storage parameter 774, which track and/or control an imager (e.g. 684 in FIG. 8) and a data store (e.g. 682 in FIG. 8), respectively, used to provide an authentication arrangement. In some such examples, the authentication engine 770 (including imager parameter 772 and storage parameter 774) may be implemented in a manner comprising at least some of substantially the same features and attributes as previously described in association with FIG. 8.

FIG. 9B is a block diagram schematically representing an example control portion 800. In some examples, control portion 800 provides one example implementation of a control portion (e.g. 217 in FIG. 4) forming a part of, implementing, and/or generally managing the example additive manufacturing devices, as well as the particular portions, components, material distributors, fluid supply, fluid dispensers, energy sources, control portion, instructions, engines, functions, parameters, and/or methods, as described throughout examples of the present disclosure in association with FIGS. 1-8B and 9B-10B. In some examples, control portion 800 includes a controller 802 and a memory 810. In general terms, controller 802 of control portion 800 comprises at least one processor 804 and associated memories. The controller 802 is electrically couplable to, and in communication with, memory 810 to generate control signals to direct operation of at least some the object formation devices, various portions and elements of the example additive manufacturing devices, as well as the particular portions, components, material distributors, fluid supply, fluid dispensers, energy sources, control portion, instructions, engines, functions, parameters, and/or methods, as described throughout examples of the present disclosure. In some examples, these generated control signals include, but are not limited to, employing instructions 811 stored in memory 810 to at least direct and manage additive manufacturing of 3D objects in the manner described in at least some examples of the present disclosure. In some instances, the controller 802 or control portion 800 may sometimes be referred to as being programmed to perform the above-identified actions, functions, etc. In some examples, at least some of the stored instructions 811 are implemented as a, or may be referred to as, a 3D print engine, an object formation engine, and the like, such as but not limited to the object formation engine 700 in FIG. 9A.

In response to or based upon commands received via a user interface (e.g. user interface 820 in FIG. 9C) and/or via machine readable instructions, controller 802 generates control signals as described above in accordance with at least some of the examples of the present disclosure. In some examples, controller 802 is embodied in a general purpose computing device while in some examples, controller 802 is incorporated into or associated with at least some of the additive manufacturing devices, as well as the particular portions, components, material distributors, fluid supply, fluid dispensers, energy sources, control portion, instructions, engines, functions, parameters, and/or methods, etc. as described throughout examples of the present disclosure.

For purposes of this application, in reference to the controller 802, the term “processor” shall mean a presently developed or future developed processor (or processing resources) that executes machine readable instructions contained in a memory or that includes circuitry to perform computations. In some examples, execution of the machine readable instructions, such as those provided via memory 810 of control portion 800 cause the processor to perform the above-identified actions, such as operating controller 802 to implement the formation of a 3D object with a particular thermal history to produce an authentication surface feature, as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 810. The machine readable instructions may include a sequence of instructions, a processor-executable machine learning model, or the like. In some examples, memory 810 comprises a computer readable tangible medium providing non-volatile storage of the machine readable instructions executable by a process of controller 802. In some examples, the computer readable tangible medium may sometimes be referred to as, and/or comprise at least a portion of, a computer program product. In other examples, hard wired circuitry may be used in place of or in combination with machine readable instructions to implement the functions described. For example, controller 802 may be embodied as part of at least one application-specific integrated circuit (ASIC), at least one field-programmable gate array (FPGA), and/or the like. In at least some examples, the controller 802 is not limited to any specific combination of hardware circuitry and machine readable instructions, nor limited to any particular source for the machine readable instructions executed by the controller 802.

In some examples, control portion 800 may be entirely implemented within or by a stand-alone device.

In some examples, the control portion 800 may be partially implemented in one of the object formation devices and partially implemented in a computing resource separate from, and independent of, the object formation devices but in communication with the object formation devices. For instance, in some examples control portion 800 may be implemented via a server accessible via the cloud and/or other network pathways. In some examples, the control portion 800 may be distributed or apportioned among multiple devices or resources such as among a server, an object formation device, and/or a user interface.

In some examples, control portion 800 includes, and/or is in communication with, a user interface 820 as shown in FIG. 9C. In some examples, user interface 820 comprises a user interface or other display that provides for the simultaneous display, activation, and/or operation of at least some of the additive manufacturing devices, as well as the particular portions, components, material distributors, fluid supply, fluid dispensers, energy sources, control portion, instructions, engines, functions, parameters, and/or methods, etc., as described in association with FIGS. 1-9B and 10A-10B. In some examples, at least some portions or aspects of the user interface 820 are provided via a graphical user interface (GUI), and may comprise a display 824 and input 822.

FIG. 10A is a flow diagram of an example method 900. In some examples, method 900 may be performed via at least some of the devices, components, material distributors, fluid supply, fluid dispensers, energy sources, instructions, control portions, engines, functions, parameters, and/or methods, etc. as previously described in association with at least FIGS. 1-9C. In some examples, method 900 may be performed via at least some of the devices, components, material distributors, fluid supply, fluid dispensers, energy sources, instructions, control portions, engines, functions, parameters, and/or methods, etc. other than those previously described in association with at least FIGS. 1-9C.

As shown at 902 in FIG. 10A, method 900 comprises additively manufacturing a 3D object including causing a first interior portion to experience a first thermal history selectably different from a second thermal history of at least second interior portions surrounding the first interior portion to include a first surface feature variation at a first exterior surface portion overlying the first interior portion, the first exterior surface portion being different in appearance than a second exterior surface portion overlying the second interior portions. As further shown at 904, method 900 comprises optically recording, and storing in memory, an image of at least one of: the first surface feature variation of the first exterior surface portion; and the second exterior surface portion.

In some examples, the method 900 may further comprise determining, at a later time, authenticity of a candidate 3D object by comparing at least one of: the stored image of the first surface feature variation at the first surface exterior portion with a corresponding first surface exterior portion of the candidate 3D object; and the stored image of the second exterior surface portion with a corresponding second exterior surface portion of the candidate 3D object. In some such examples, such determination may be implemented via the authentication engine 770 described in association with at least FIG. 9A and/or in accordance with at least some of substantially the same features and attributes of the example described in association with at least FIG. 8.

In some examples, the first surface feature variation may sometimes be referred to as an authentication surface feature, an authentication surface mark, an authentication surface colorization, etc. in the manner previously described throughout examples of the present disclosure.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A non-transitory machine-readable storage medium, encoded with instructions executable by a processor, comprising:
instructions to generate data representing a three-dimensional object model to additively manufacture a first three-dimensional object including a first interior portion having a first thermal history different from a second thermal history of at least second interior portions surrounding the selectable first interior portion to induce a first surface feature at a first exterior surface portion overlying the first interior portion.

2. The storage medium of claim 1, wherein the first surface feature is different from a substantially uniform second surface feature of a second exterior surface portion surrounding the first exterior surface portion, the second surface feature overlying the at least second interior portions.

3. The medium of claim 1, the instructions to cause the first thermal history by selectably forming the first interior portion according to a first degree of fusion of a build material and to cause the second thermal history by forming the at least second interior portions according to a second degree of fusion, the first degree of fusion being selectably different from the second degree of fusion.

4. The non-transitory machine readable medium of claim 3, wherein the first degree of fusion is selectably different from the second degree of fusion based on application to the build material in the selectable first interior portion of a selectable parameter regarding least one of:
a detailing agent; and
a fusing agent.

5. The non-transitory machine readable medium of claim 1, wherein the instructions are to implement the first interior portion via a selectable location within the three-dimensional object, which will cause formation of the first surface feature at the first exterior portion.

6. The non-transitory machine readable medium of claim 3, wherein the selectable location comprises a selectable depth of the first interior portion relative to the first exterior surface portion.

7. The non-transitory machine readable medium of claim 1, wherein the first interior portion comprises a selectable volume and shape.

8. The non-transitory machine readable medium of claim 1, wherein the instructions are to implement the first interior portion as a pseudo-randomly generated shape.

9. A print control portion comprising:
a processor programmed to additively form a 3D object including a selectable first interior portion at which at least one thermal parameter of the build material is selectably different from thermal parameters of at least second interior portions surrounding the selectable first interior portion to induce a surface authentication mark at a first exterior surface portion overlying the first interior portion, the surface authentication mark being visually distinguishable from a substantially uniform second surface feature of a second exterior surface portion surrounding the first exterior surface portion.

10. The print control portion of claim 9, wherein the print control portion is at least one of:
in communication with a 3D printer; and
incorporated as part of the 3D printer,
wherein the 3D printer comprises:
a build unit including a build platform;
a build material distributor to distribute a build material on the build platform;
a fluid dispenser to selectively apply at least one agent to the build material, the at least one agent comprising a detailing agent and a fusing agent;
an energy source to apply energy to cause fusing, via the at least one agent, of the build material to form the 3D object of the build material,
wherein the print control portion is to control at least the material distributor, the fluid dispenser, and the energy source to additively form the 3D object including the surface authentication mark at the first exterior surface portion.

11. The print control portion of claim 9, wherein the at least one thermal parameter for the first interior portion is based on application to the build material in the selectable first interior portion of a selectable parameter regarding least one of a detailing agent and a fusing agent.

12. The print control portion of claim 9, wherein the print control portion is to implement the first interior portion via a selectable location within the three-dimensional object, which will cause formation of the surface authentication mark at the first exterior portion, the selectable location including a selectable depth relative to the first exterior portion.

13. The print control portion of claim 9, wherein the print control portion is to implement the first interior portion as at least one of a randomly-generated shape, a randomly-generated volume, and a randomly-generated degree of fusion.

14. A method comprising:
additively manufacturing a three-dimensional object including causing a selectable first interior portion to experience a first thermal history different from a second thermal history of at least second interior portions surrounding the selectable first interior portion to induce a first surface feature variation at a first exterior surface portion overlying the first interior portion, the first exterior surface portion being different in appearance from a second exterior surface portion overlying the second interior portions; and
optically recording, and storing in memory, an image of at least one of:
the first surface feature variation of the first exterior surface portion; and
the second exterior surface portion.

15. The method of claim 14, comprising:
determining, at a later time, authenticity of a candidate 3D object by comparing at least one of:
the stored image of the first surface feature variation at the first surface exterior portion with a corresponding first surface exterior portion of the candidate 3D object; and
the stored image of the second exterior surface portion with a corresponding second exterior surface portion of the candidate 3D object.
